(19) United States
(12) Patent Application Publication
(10) Pub. No.: US 2023/0289668 A1
(43) Pub. Date: Sep. 14, 2023

(54) System and Method for Fractional Ticketing in an NFT-based Community

(71) Applicants: James Tyler Frix, Athens, GA (US); Jonathan Wallace, Athens, GA (US)

(72) Inventors: James Tyler Frix, Athens, GA (US); Jonathan Wallace, Athens, GA (US)

(21) Appl. No.: 18/119,675

(22) Filed: Mar. 9, 2023

Related U.S. Application Data
(60) Provisional application No. 63/319,130, filed on Mar. 11, 2022.

(51) Int. Cl. G06Q 10/02; G06Q 20/36; G06Q 30/0601

(52) U.S. Cl. CPC G06Q 10/02; G06Q 20/36; G06Q 30/0643; G06Q 2220/00

(57) ABSTRACT

A system and method for using fractional ticketing manages access and attendance at an event hosted by the host platform or entity behind an NFT-based community. An NFT-based fractional ticketing system and method according to the solution may leverage the ability of an NFT-based community platform to airdrop NFT-based assets to members of its community. In an exemplary embodiment, every member of an NFT-based community may be airdropped a voucher or coupon associated with a limited attendance event organized by the community platform. The event may be live in nature (like a tailgate party before a college football game) or virtual in nature (such as an online symposium featuring a famous keynote speaker). The coupons may each be in the form of an NFT and, as such, uniquely identifiable with the NFT-based community and the event it organized and the digital wallet to which it was dropped. Notably, access to the event may be subject to presentation of a ticket (also in the form of an NFT) by community members, the ticket being acquired via acquisition of a predetermined number of coupons from other members.

### TECHNICAL FIELD

The present disclosure relates to blockchain systems and methods for leveraging non-fungible tokens (NFTs) to implement a fractional ticketing function in an NFT-based community.

### BACKGROUND

Blockchain technology uses a distributed ledger system in which the data associated with transactions is cryptographically encoded and stored as blocks in the ledger. In the distributed ledger, the blocks are cryptographically linked to one another to form a “chain” in such a way that data stored in the ledger is virtually impossible to delete or modify. The ledger is “distributed” in that every node on the blockchain network has a copy of the ledger and receives a copy of the updated ledger anytime a new transaction on the blockchain is performed and the corresponding cryptographically-encoded data is added as a block on the chain.

Each user, i.e., node, on the network has a private key and a public key. The public keys are used by the nodes on the network to identify and communicate with one another, whereas each user's private key, which is not known to the other users of the network, is needed to perform transactions. The public and private keys are used in cryptographic hashing algorithms to perform transactions that result in the cryptographically-encoded blocks being added to the chain once they have been validated. In general, when a user requests a transaction on the network, a cryptographically-encoded block is created and broadcast to all of the nodes on the network. Nodes of the network have processors that perform a consensus algorithm that processes the block to validate it. Once the block is validated, it is added to the ledger and the updated ledger is broadcast to all the nodes of the network.

Blockchain networks vary depending on the type of blockchain technology used, but they all have the above attributes in common. Because it is virtually impossible to delete or modify data stored in the blockchain, blockchain networks are well suited for use in performing a variety of business transactions and for transacting cryptocurrency. In cryptocurrency blockchain networks, fungible tokens (FTs) represent the currency that is transacted, whereas in other types of blockchain networks, non-fungible tokens (NFTs) are used to represent non-fungible items, such as collectible items (e.g., baseball cards, art work, etc.), which can often be purchased on the network using cryptocurrency, held, traded, bought and sold. FTs and NFTs are cryptographically-encrypted, and transactions that involve them become cryptographically-encrypted blocks of the distributed ledger.

Interestingly, technology that leverages block-chains for minting and recording NFTs has exploded in recent months. As may be understood by one of ordinary skill in the art of NFTs, a generative artwork is uniquely built from a digital base concept that is modified according to a script that executes at the time of an NFT mint transaction. A purchaser who wants to own a unique generative art enters into a “smart contract” and, upon doing so, causes a coded script to execute and generate a unique version of the generative art represented by the newly minted NTT. The purchaser owns the NTT once minted and so owns and controls the unique piece of generative art represented by the NET. The script is built into the smart contract that, once entered by the purchaser, executes the moment the NFT mint transaction occurs. The script takes a seed input, in the form of a hash string which is a long hexadecimal string generated on the blockchain in a pseudo-random manner when the token is minted.

While NFTs are often used to cryptographically encode a collectible item, such as a unique representation of a generative digital art (see, for example, “Chromic Squiggles” at https://chromie-squiggles.com/), an NFT may be used for more than that. An example of a more comprehensive leveraging of NFT technology can be experienced through NFT-based communities that offer members access to, among other things, certain online services (such as exclusive chat rooms and auctions) and live events (such as galas and sporting event tailgates). Community membership in an NFT-based community is dictated by ownership of at least one community-branded NFT minted by a unique community script executed in response to a smart contract, similar to that which has been described above. Exclusive ownership and control of a community-branded NFT (often associated with a unique generative art) gives a community member access to all the services and experiences the NFT-based community has to offer—the NTT is the member's digital ticket to access.

A problem that arises for NFT-based communities is managing attendance or participation by community members when there is a need or desire to limit attendance. As a non-limiting example, a five thousand member NFT-based community associated with a college athletics program may plan and promote a live event in the form of a tailgate party. The sheer number of the community members may prohibit accommodation of all community members at the event (perhaps the event can only accommodate 500, for example), although as an NFT holder each community member may technically have a “right” to attend the event. A corollary to the above problem is that there is often a decreased incentive to become a member of an NFT-based community when the purchaser, for whatever reason(s), cannot take advantage of, or is just not interested in taking advantage of, all the perks and access to community events that comes along with NFT ownership. The above problems, although suggested in the context of a live, in-person event with limited capacity, may also exist in NFT-based communities that desire to limit participation or access to virtual events and features in an effort to generate interest and create demand that comes from exclusivity.

Therefore, there is a need in the art for a system and method that NFT-based communities can use to limit access to community events and/or features. Further, there is a need in the art for a system and method that provides members of an NFT-based community to buy/sell/share perks and access that goes along with NFT-based community membership without having to rent or temporarily release control of a valuable NFT token uniquely associated with, and owned by, the member. More specifically, there is a need in the art for a system and method of fractional ticketing in an NFT-based community.

### SUMMARY

The present disclosure describes various embodiments, as well as features and aspects thereof, of a system and method for using fractional ticketing to manage access and attendance at an event hosted by the host platform or entity behind an NFT-based community. An NFT-based fractional ticketing system and method according to the solution may leverage the ability of an NFT-based community platform to airdrop NFT-based assets to members of its community. In an exemplary embodiment, every member of an NFT-based community may be airdropped a voucher or coupon associated with a limited attendance event organized by the community platform. The event may be live in nature (like a tailgate party before a college football game) or virtual in nature (such as an online symposium featuring a famous keynote speaker). The coupons may each be in the form of an NFT and, as such, uniquely identifiable with the NFT-based community and the event it organized and the digital wallet to which it was dropped. Notably, access to the event may be subject to presentation of a ticket (also in the form of an NFT) by community members, the ticket being acquired via acquisition of a predetermined number of coupons from other members.

In accordance with an exemplary embodiment of the solution for using non-fungible tokens (“NFTs”) of a blockchain network for fractional ticketing in an NFT-based community having a plurality of members, each member is associated with a unique digital wallet and at least one community-branded NFT. The solution may leverage an online NFT-based community platform in communication with the unique digital wallets of the plurality of members. An NFT-based community event is established, and a maximum attendance at the event is set for a number less than the plurality of members. Next, at least one NFT-based coupon is airdropped to each unique digital wallet associated with an NFT-based community member. Then, defined is a minimum number of NFT-based coupons required for a given NFT-based community member to redeem for an NFT-based ticket to the event. The method further includes providing an online marketplace for the plurality of members to buy or sell the NFT-based coupons, such that for each member aggregating through the marketplace an amount of NFT-based coupons that meets or exceeds the defined minimum number of NFT-based coupons, an NFT-based ticket is airdropped to the unique digital wallet associated with the member. The NFT-based ticket may be presented for access to the event.

The system and method may be configured to digitally the NFT-based coupons after redemption for an NFT-based ticket. The system and method may associate a visual rendering with the NFT-based tickets (the visual rendering may be unique in some one or more ways with the particular NFT-based ticket with which it is associated). For example, the visual rendering may be a replicate of a traditional, paper ticket. The visual rendering associated with an NFT-based ticket may be modified at the time of access to the event or later in response to event-based triggers or experiences or activities. Moreover, the modification may be in the form of a digital signature or rarity designation, thereby operating to distinguish the modified NFT-based ticket from other NFT-based tickets. Finally, the system and method may provide an online marketplace for the plurality of NFT-based community members to buy or sell the NFT-based tickets, as commemorative NFTs, after the event.

These and other features and advantages will become apparent from the following description, drawings and claims.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion and illustration. Wherever applicable and practical, like reference numerals refer to like elements.

FIG. 1 is a logical flowchart illustrating an exemplary embodiment of a method for fractional ticketing in an NFT-based community according to the solution; and

FIG. 2 is a block diagram of the blockchain network of the present disclosure in accordance with a representative embodiment of the solution for fractional ticketing in an NFT-based community.

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

In this description, if used, the term “portable computing device” (“PCD”) is used to describe any device operating on a limited capacity power supply, such as a battery. Although battery operated PCDs have been in use for decades, technological advances in rechargeable batteries coupled with the advent of fourth generation (“4G”) and fifth generation (“5G”) wireless technology have enabled numerous PCDs with multiple capabilities. Therefore, a PCD may be a cellular telephone, a satellite telephone, a pager, a PDA, a smartphone, a navigation device, a tablet, a smartbook or reader, a media player, a combination of the aforementioned devices, a laptop computer with a wireless connection, among others.

In this description, the term “NFT” refers to a non-fungible token that is a unique digital asset residing on a blockchain. A given NFT may be associated with a particular digital or physical asset and a license to use the asset for a specified purpose. NFTs are created when blockchains string records of cryptographic hash, a set of characters identifying a set of data, onto previous records, thereby creating a chain of identifiable data blocks. This cryptographic transaction process ensures the authentication of each digital file by providing a digital signature that is used to track NFT ownership.

In this description, the term “wallet” refers to a module in the form of a digital repository of NFTs uniquely associated with a member of an NFT-based community.

In this description, the term “airdrop” refers to the process of issuing a token or coupon, or multiple tokens or coupons, to the wallet of a holder of one or more NFTs associated with an NFT-based community. A token or coupon may be in the form of an NFT. A token or coupon issued to a community member may be used in combination with additional acquired tokens or coupons to gain access to a given community event. Tokens or coupons may only be issued via airdrop to an NFT-based community member. Depending on embodiment, a token or coupon may expire at a certain time and cease to be useful for gaining access to an NFT-based community event. In other embodiments, a token or coupon may continue to exist indefinitely in the digital wallet of a community member in a commemorative form, may be configured for modification to display a “badge” or other indicator of attendance at an event associated with the token or coupon, and may be transferable for value among community members or other NFT buyers or collectors. Other aspects and features envisioned in association with airdropped tokens or coupons used by embodiments of the solution will be provided in the description that follows.

The following written description explains various embodiments of a method and system for fractional ticketing in an NFT-based community and/or across NFT-based communities. This written description refers to the appended drawings to supplement the written explanation. As such, the written words should not be construed as limitations. Numerous specific details are explained in the written description and/or depicted in the drawings to provide an enabling understanding of the various embodiments to a person having ordinary skill in the art of blockchain technology and non-fungible tokens. Some details, however, need not be expressly explained because they would be readily apparent and understood by a person having ordinary skill in the art of blockchain technology and non-fungible tokens. For example, a person having ordinary skill in the art would be able to configure a network and code application software and leverage the blockchain for implementation of a fractional ticketing methodology in an NFT-based community or platform after reviewing this specification and drawings.

Embodiments of the solution comprise a fractional ticketing system and method useful within an NFT-based community and technological space to, inter alia, limit event attendance to a subset of community members who have acquired one of a limited number of NFT-based tickets (where community membership is defined by ownership of at least one purchased community-branded or platform-branded NFT), avoid fraudulent or counterfeit tickets to the event, avoid any need to rent or borrow a community-branded NFT of another member, and create commemorative or collectible NFTs associated with the event.

It is envisioned that an NFT-based fractional ticketing system and method may leverage the ability of an NFT-based community platform to airdrop NFT-based assets to members of its community. In an exemplary embodiment, every member of an NFT-based community may be airdropped an NFT-based voucher or coupon associated with a limited attendance event organized by the community platform. The event may be live in nature (like a tailgate party before a college football game) or virtual in nature (such as an online symposium featuring a famous keynote speaker). The coupons may each be in the form of an NFT and, as such, uniquely identifiable with the NFT-based community and the event it organized. Notably, access to the event may be subject to presentation of a ticket (also in the form of an NFT) by community members, the ticket being acquired via acquisition of a predetermined number of coupons from other members.

For example, a 5000-member NFT-based community may host an event for 500 of its members. For ease of explanation, assume that each of the 5000 members owns and controls one platform-branded NFT that represents their membership in the community. In such a scenario, the NFT-based community platform may airdrop one NFT-based coupon to the digital wallet of each member of the community (one coupon per platform-branded NFT). As would be understood by one of ordinary skill in the art, a digital wallet is hosted on a blockchain, is associated with a unique identifier, and “stores” any and all blockchain recorded assets, such as cryptocurrency and NFTs, held by the user of the wallet.

Returning to the exemplary scenario, the NFT-based community platform, in order to control attendance at the event, may dictate that any community member with ten (10) coupons may redeem the ten coupons for a ticket to the event. In this way, a marketplace is created by and among the NFT-based community members, as those members who desire to attend the event will seek to acquire nine (9) additional coupons from those community members who would rather sell or trade their coupons than attend the event themselves. Coupons may be acquired by trading other NFT-based assets, exchanging cryptocurrency, or exchanging other values, as would be understood by one of ordinary skill in the art of cryptocurrency, nonfungible tokens, and blockchain technology in general. Notably, because in the example there is a total of 5000 airdropped coupons and it takes the acquisition of ten (10) coupons to acquire a ticket to the event, only 500 NFT-based tickets may ultimately be minted. Any member acquiring 10 coupons may redeem those coupons and receive a newly minted NFT (i.e., a ticket) that can be used to gain access to the event. The coupons may be “burned” or otherwise deleted by the platform when redeemed by a community member for an NFT-based ticket.

Advantageously, because membership in the community is determined by ownership of a platform-branded NFT, but access to the event is determined by ownership of a NFT-based ticket that results from redemption of a plurality of NFT-based coupons, there is no need for NFT-based community members to loan or rent their platform-branded NFTs to other digital wallet users (whether the other digital wallet users are members themselves of the NFT-based community or not) who want to attend the NFT-based community event. Additionally, because the platform-branded NFTs, the coupon NFTs, and the ticket NFTs are all recorded on the blockchain, fraudulent duplication or forgery or counterfeit of a ticket is all but impossible.

A number of variations and alternative embodiments of the solution are envisioned. For example, it is envisioned that an NFT-based ticket may be associated with a unique digital artwork that may be displayed on the screen of a PCD by a community member seeking entry into the event. Presentation of the NFT-based ticket may be queried against the blockchain to authenticate the ticket. As a non-limiting example, the unique digital artwork may be a rendering of a traditional, paper ticket. Upon presentation of the NFT-based ticket in order to enter the event, the unique digital artwork may be modified to render what looks like a paper ticket stub. The metadata of the NFT-based ticket may be updated to reflect that the NFT-based ticket had been redeemed for entry into the event (thereby recording that the community member attended the event) or, alternatively, an entirely new NFT associated with the “torn ticket stub” image may be minted and dropped to the digital wallet of the member. Either way, and advantageously, the final NFT held by the member (i.e., the NFT associated with the redeemed ticket or the “torn ticket stub”) may be held in the digital wallet of the member as a commemorative NFT-based item (and, consequently, later traded or sold). Moreover, once in the event, the NFT-based ticket may be modified with digital signatures, or pictures taken by the member at the live event, or rarities, or other modifications that work to commemorate the event experience, document attendance, provide accolades, or otherwise drive value into the NFT-based ticket.

It is further envisioned that one or more “golden tickets” may be airdropped to random or preferred community members at the time of the NFT-based coupon airdrop. In this way, a select number of members may receive in their wallets full tickets to the event without having to acquire and redeem coupons. A “golden ticket” may be associated with additional or special perks at the event or other aspects that make it special, and thereby more valuable or desirable within the community, when compared to NFT-based tickets resulting from a redemption of NFT-based coupons. Advantageously, a holder of a “golden ticket” in some embodiments may be able to sell the golden ticket and/or sell airdropped NFT-based coupons without having to forego attendance at the event. It is further envisioned that so-called “golden tickets” may themselves be fractionalized, much like the coupons represent fractional rights of platform-branded NFT holders, and so create a demand among NFT-based community members to acquire from other members additional fractions of a “golden ticket” in order to acquire a full ticket and the perks that go along with it.

In some embodiments, the NFT-based platform may dictate that the airdropped coupons expire after the event (thereby creating demand among members to buy/sell/trade coupons) while the final NFT-based ticket used to gain entry or access to the event lives on as a commemorative, NFT-based asset. Moreover, and as envisioned above, the NFT-based ticket may be digitally signed or otherwise altered during or after the event, an aspect that may operate to increase value of the NFT-based ticket.

It is also envisioned that in some embodiments of the solution the NFT-based coupons may be assigned rarity values (e.g., “common,” “rare,” “epic,” or “legendary”) in order to create further demand among community members to acquire a certain combination of coupons that, when redeemed, will cause the minting of an NFT-based ticket that gives its holder access to special or certain perks of the event.

Another variation of the novel system and method is to leverage airdrop functionality to distribute “full tickets” (in the form of NFTs) to every member of an NFT-based community (assuming the event associated with the tickets can accommodate all members of the community, such as a virtual event). It is envisioned that a benefit of dropping full tickets to all holders of platform-branded NFTs, as opposed to simply requiring the members to just present their platform-branded NFTs for entry into the event, is that the NFT-based ticket could later be expired by the platform or commemorated (as described above), thereby generating NFT-based assets for the community members that can be later bought/sold/or traded. It is further envisioned that in such an embodiment that drops full tickets to NFT-based community members, an algorithm that randomly identifies a limited number of members in the NFT-based community may be leveraged for a limited attendance event.

The present disclosure teaches representative embodiments of a blockchain system and methods that are used to implement fractional ticketing in an NFT-based community. Some embodiments of the present disclosure are directed to processes that are performed by a handheld device (a PCD) uniquely associated with a user and digital wallet while other embodiments of the present disclosure are directed to processes that are performed by one or more processors of the blockchain network, as would be understood by one of ordinary skill in the art.

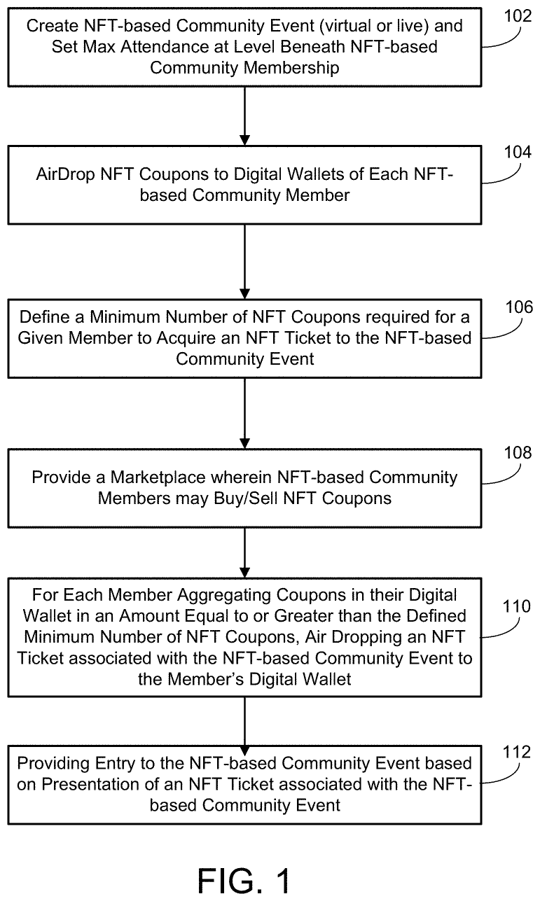

Turning now to the illustrations, FIG. 1 is a logical flowchart illustrating an exemplary embodiment of a method for fractional ticketing in an NFT-based community according to the solution. At block 102, the host platform of an NFT-based community may create an NFT-based community event. The event may be a live event or a virtual event planned for the benefit of a subset of the total membership of the NFT-based community. The host platform may set a maximum attendance at the event, the maximum attendance number being less than the total membership count of the NFT-based community.

At block 104, the host platform may generate NFT-based coupons and airdrop those coupons to the digital wallets of the members of the NFT-based community, where the number of coupons dropped to a given member is a function of the number and/or type and/or grade of platform-branded NFTs purchased and held by the member. At block 106 the host platform defines the minimum number of NFT-based coupons that a given community member must acquire in order to redeem the coupons for an NFT-based ticket that can be used by the member to gain access to the event.

At block 108, the host platform may provide a marketplace for the membership to buy/sell/trade coupons and tickets. Notably, while the marketplace may be provided by the host platform of the NFT-based community, it is envisioned that the marketplace may be operated by other NFT marketplace providers such as, but not limited to, opensea.io or raribles.com. At block 110, for each digital wallet holder or member of the NFT-based community that acquires the requisite number of coupons for redemption into a ticket, the host platform may airdrop a completed NFT-based ticket for access to the event. Like the coupons, in certain embodiments, the completed NFT-based ticket may be bought/sold/traded by and between digital wallet holders. Finally, at block 112, any holder of a completed ticket may present the NFT-based ticket for entry to the event and access to perks and functions of the event.

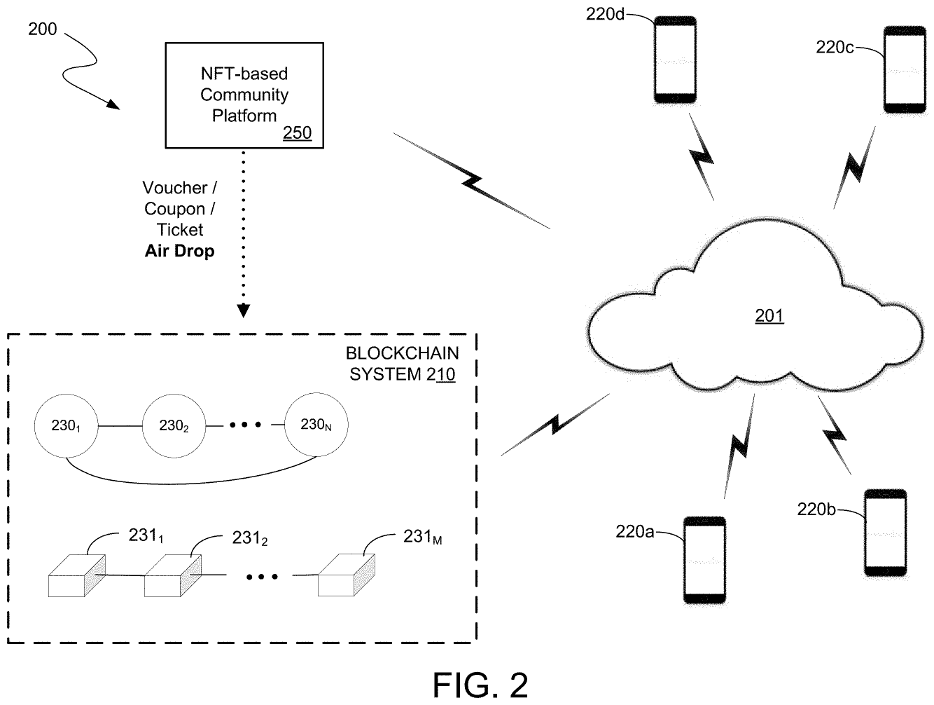

FIG. 2 is a block diagram of the blockchain network 200 of the present disclosure in accordance with a representative embodiment of the solution for fractional ticketing in an NFT-based community 220. The blockchain network 200 comprises a blockchain system 210 comprising nodes 230₁ through 230_{N}, where N is a positive integer that is greater than or equal to 1. Each node comprises one or more processors that perform the processes necessary for recording transactions and updating the blockchain. A transaction may be, for example, the minting or trading or sale of a platform-branded NFT, an NFT-based coupon, an NFT-based ticket, a modified NFT, etc. The blockchain system 210 is in communication via a wired or wireless link with an external network 201, which can be a public or private network or a combination of public and/or private networks. Personal computing devices 220a-220d are associated with digital wallet holders/users that form the membership of an NFT-based community. The total membership in an NFT-based community may be any number and, as such, the depiction of just four devices 220a-220d is not an indication that embodiments of the solution are limited to use by and among just four users. Running apps associated with a host platform 250 of an NFT-based community and/or a digital wallet, the PCD handheld devices 220a-220d can be used to perform one or more of the operations described above to communicate with the blockchain system 210 via the network 201.

The nodes 230₁-230_{N} are interconnected by a network that allows them to communicate with one another, and each of the nodes 230₁-230_{N} comprises one or more processors that are configured to allow the nodes to perform blockchain operations such as those described above. The processors of the nodes do not all have to have the same configurations and do not all have to perform the same operations.

When the processes described above are performed to trigger creation of a new NFT (whether associated with a platform-branded NFT, an NFT-based coupon, an NFT-based ticket, etc.), a new block associated with the NFT is added to the blockchain. The blocks 231₁-231ₘ in the illustration represent the blocks of the blockchain and the lines interconnecting the blocks 231₁-231ₘ represent the encryption that links the blocks together in the blockchain, where M is a positive integer that is greater than or equal to 1. The blockchain comprising the cryptographically-linked blocks 231₁-231ₘ is essentially the distributed ledger of the blockchain network 200.

It should be noted that the inventive principles and concepts have been described with reference to representative embodiments, but that the inventive principles and concepts are not limited to the representative embodiments described herein. Although the inventive principles and concepts have been illustrated and described in detail in the drawings and in the foregoing description, such illustration and description are to be considered illustrative or exemplary and not restrictive; the invention is not limited to the disclosed embodiments. Other variations to the disclosed embodiments can be understood and effected by those skilled in the art, from a study of the drawings, the disclosure, and the appended claims.

What is claimed is:

1. A method for using non-fungible tokens (“NFTs”) of a blockchain network for fractional ticketing in an NFT-based community having a plurality of members, each member associated with a unique digital wallet and at least one community-branded NFT, the method comprising:
establishing an NFT-based community event, wherein a maximum attendance at the event is set for a number less than the plurality of members;
airdropping at least one NFT-based coupon to each unique digital wallet associated with an NFT-based community member;
defining a minimum number of NFT-based coupons required for a given NFT-based community member to redeem for an NFT-based ticket to the event;
providing an online marketplace for the plurality of members to buy or sell the NFT-based coupons; and
for each member aggregating through the marketplace an amount of NFT-based coupons that meets or exceeds the defined minimum number of NFT-based coupons, airdropping an NFT-based ticket to the unique digital wallet associated with the member, wherein the NFT-based ticket may be presented for access to the event.

2. The method of claim 1, further comprising:
digitally burning the NFT-based coupons after redemption for an NFT-based ticket.

3. The method of claim 1, further comprising:
associating a visual rendering with the NFT-based ticket.

4. The method of claim 3, wherein the visual rendering replicates a paper ticket.

5. The method of claim 3, further comprising:
modifying the visual rendering associated with the NFT-based ticket when the NFT-based ticket is presented for access to the event.

6. The method of claim 3, further comprising:
modifying the visual rendering associated with the NFT-based ticket based on activities associated with the event.

7. The method of claim 6, wherein the modification of the visual rendering is in the form of a digital signature.

8. The method of claim 7, wherein the digital signature is in the form of an NFT associated with a community member.

9. The method of claim 1, further comprising:
assigning a rarity value to one or more of the NFT-based tickets.

10. The method of claim 1, further comprising:
providing an online marketplace for the plurality of members to buy or sell the NFT-based tickets after conclusion of the event.

11. A system for using non-fungible tokens (“NFTs”) of a blockchain network for fractional ticketing in an NFT-based community having a plurality of members, each member associated with a unique digital wallet and at least one community-branded NFT, the system comprising:
an online NFT-based community platform in communication with the unique digital wallets of the plurality of members, the platform configured to:
establish an NFT-based community event, wherein a maximum attendance at the event is set for a number less than the plurality of NFT-based community members;
airdrop at least one NFT-based coupon to each unique digital wallet associated with an NFT-based community member;
define a minimum number of NFT-based coupons required for a given NFT-based community member to redeem for an NFT-based ticket to the event;
provide an online marketplace for the plurality of members to buy or sell the NFT-based coupons; and
for each member aggregating through the marketplace an amount of NFT-based coupons that meets or exceeds the defined minimum number of NFT-based coupons, airdrop an NFT-based ticket to the unique digital wallet associated with the member, wherein the NFT-based ticket may be presented for access to the event.

12. The system of claim 11, wherein the platform is further configured to:
digitally burn the NFT-based coupons after redemption for an NFT-based ticket.

13. The system of claim 11, wherein the platform is further configured to:
associate a visual rendering with the NFT-based ticket.

14. The system of claim 13, wherein the visual rendering replicates a paper ticket.

15. The system of claim 13, wherein the platform is further configured to:
modify the visual rendering associated with the NFT-based ticket when the NFT-based ticket is presented for access to the event.

16. The system of claim 13, wherein the platform is further configured to:
modify the visual rendering associated with the NFT-based ticket based on activities associated with the event.

17. The system of claim 16, wherein the modification of the visual rendering is in the form of a digital signature.

18. The system of claim 17, wherein the digital signature is in the form of an NFT associated with a community member.

19. The system of claim 11, wherein the platform is further configured to:
assign a rarity value to one or more of the NFT-based tickets.

20. The system of claim 11, wherein the platform is further configured to:
provide an online marketplace for the plurality of members to buy or sell the NFT-based tickets after conclusion of the event.
